(19) United States
(12) Patent Application Publication
(10) Pub. No.: US 2017/0353591 A1
(43) Pub. Date: Dec. 7, 2017

(54) Smartphone Charger

(71) Applicant: Eyal Abramovich, Tel Aviv (IL)

(72) Inventor: Eyal Abramovich, Tel Aviv (IL)

(73) Assignee: Jeffery Rudes, Tarzana, CA (US)

(21) Appl. No.: 15/607,489

(22) Filed: May 28, 2017

Related U.S. Application Data
(60) Provisional application No. 62/346,124, filed on Jun. 6, 2016.

(51) Int. Cl. H04M 1/02; H02J 7/02; H02J 7/00; H04B 1/3883; H01R 24/68

(52) U.S. Cl. CPC H04M 1/0262; H04B 1/3883; H01R 24/68; H02J 7/0044; H02J 7/02

(57) ABSTRACT

A slim cordless all-in-one charger capable of interfacing with external power sources such as AC wall outlet or USB port without the need of us of bulky cables. The device can charge its built in mobile rechargeable battery and, or a smartphone phone simultaneously. The device has a built-in retractable charging dock with a detachable smartphone charging adapter having the capability to charge wide range of smartphone models and allow conveniently use of the smartphone at the same time. At least one power output port for direct smartphone charging. The device can have an optional securing system to secure the smartphone to the device while it is under charging, USB power output port and an optional retractable smartphone desk stand.

### CROSS-REFERENCE TO RELATED APPLICATIONS

This application claims the benefit of U.S. Provisional Application No. 62/346,124, filed Jun. 6, 2016, which is hereby incorporated herein by reference in its entirety.

### BACKGROUND

As of today, the smartphone became the most personal device on the market. Consumers use it for work, communication, entertainment and more during all time of the day. One of the biggest drawback of the smartphone is its limited mobile battery source. The market is full of competitive mobile battery charging devices. These mobile devices are charged while connected to a power source and can charge a smartphone without being connected to a wall or desk power outlet. Most of these devices require the use of an external AC wall chargers or bulky cables and are inconvenient to carry them around nor charge the smartphone and use it at the same time.

The present invention is convinced the above problems and provides an improvement to overcome these problems with an all-in-one thin body structure.

As of today, the smartphone is perhaps the most commonly used personal device on the market. Consumers use it for work, communication, entertainment and more during all hours of the day. One of the biggest drawbacks of the smartphone is its limited mobile battery life. The market is full of competitive mobile battery charging devices. These mobile devices are charged while connected to a power source and can charge a smartphone without being connected to a wall or desk power outlet. Most of these devices require the use of an external AC wall chargers or bulky cables and are inconvenient to carry.

While battery technology has made significant improvements, battery technology has not evolved to the point where devices are capable of storing sufficient power to keep devices operational for extended periods of time.

Prior solutions to this problem, as for instance as set forth in commonly assigned U.S. Pat. No. 9,438,298, hereby incorporated as though fully set forth herein, provides a charger apparatus for charging a rechargeable device, including a floating base bar having a DC plug mounted thereon. The DC plug providing DC voltage to a charging port of a rechargeable device. The floating base bar supporting said rechargeable device during charging. The floating base bar moving from a stowed configuration in which said floating base bar and said DC plug conform to the slim shape of said casing, to a charging stance in which floating said floating base bar projecting beyond said casing such that said DC plug is exposed from said casing, and such that said floating base bar can support said rechargeable device. It was discovered that some cell phones have protective cases that create a cavity which must be traversed before a plug can access the charging port of the rechargeable device. In addition a plurality of unique and proprietary interfaces exist on the rechargeable devices. Therefore there is a need for a charging apparatus that can work with a wide variety of rechargeable devices including devices with bulky protective cases, and with evolving and proprietary interfaces all without the need for cumbersome wire which have been previously recognized as cumbersome and prone to damage. The present invention overcomes these problems with an all-in-one charging system which can charge devices with bulky protective cases, adapt to evolving and proprietary interfaces without cumbersome wires.

### SUMMARY

According to the present invention a slim cordless all-in-one smartphone charger has a capability to interface external power sources such as AC wall outlet or USB port without the need of us of bulky cables. The device can charge it's built in mobile rechargeable battery and, or a smartphone phone simultaneously. The device has a built-in retractable charging dock with a detachable smartphone charging adapter having the capability to charge wide range of smartphone models and allow conveniently use of the smartphone at the same time. At least one power output port for direct smartphone charging. The device can have an optional securing system to secure the smartphone to the device while it is under charging, USB power output port and an optional retractable smartphone desk stand all in a thinned structure as will describe further in more details.

One embodiment of the present invention includes an apparatus for charging a rechargeable device, including one or more electrically conductive features folded flat inside the body of the apparatus. Wherein an apparatus left arm and an apparatus right arm are folded flat and a rechargeable device charging adapter is connected to the apparatus and a push button is connected to the apparatus from the other side of the rechargeable device charging adapter is released from the apparatus if the push button is pressed, whereby the rechargeable device charging adapter is released and another type of rechargeable device charging adapter may be affixed and whereby said another type of rechargeable device charging adapter supports a different rechargeable device charging connector.

In another embodiment of the invention an apparatus includes electrically conductive features folded flat inside the body of the apparatus includes a cigarette lighter adapter and a wall outlet. In addition the apparatus conductive features may include one of a wall outlet and a cigarette lighter adapter.

In yet another embodiment the body of the apparatus includes a battery and the battery is operatively interfaced with a rechargeable device charging adapter. In yet another embodiment the body of the apparatus includes an integral battery and the battery is operatively interfaced with the rechargeable device charging adapter and the rechargeable device charging adapter has a first and a second side and the first side is configured to operatively interface with the apparatus and the second side is configured to operatively interface with the rechargeable device.

Another embodiment includes an apparatus wherein the body of the apparatus includes an integral battery and the battery is operatively interfaced with the rechargeable device charging adapter and a universal serial bus interface. To be clear, circuitry well known in the art may be used to convert power from the wall outlet or the cigarette lighter to a form which can charge the battery. It is also contemplated that both the rechargeable device and the battery can charge at the same time, and that the rechargeable device can be operated off the integral battery.

### BRIEF DESCRIPTION OF THE DRAWINGS

FIG. 1. Front view of the present invention while features are folded flat inside the body of the device;

FIG. 2. Back view of the present invention while features are folded flat inside the body of the device;

FIG. 3. Side view of the present invention while features are folded flat inside the body of the device;

FIG. 4. Isometric view of the present invention while features are folded flat inside the body of the device;

FIG. 5. Isometric view of the present invention while built-in dock and USB input cable are retracted;

FIG. 6. Isometric view of the present invention while built-in dock and USB input cable are retracted;

FIG. 7. Isometric view of the present invention while built-in dock, USB input cable, AC prongs and desk stand are retracted;

FIG. 8. Side view of the present invention while built-in dock, USB input cable, AC prongs and desk stand are retracted;

FIG. 9. Isometric view of the present invention while built-in dock, USB input cable, AC prongs and desk stand are retracted. And smartphone charging adapter is detached;

FIG. 10. Side view of the present invention while built-in dock, is retracted and a smartphone is connected to the charging adapter and mounted to the charging dock;

FIG. 11. Isometric view of the present invention while built-in dock, and desk stand are retracted and a smartphone is mounted to the charging dock;

FIG. 12. Side view of the present invention while built-in dock, AC prongs are retracted and a smartphone is mounted to the charging dock;

FIG. 13. Isometric view of the present invention while built-in dock, USB input cable, AC prongs and desk stand are retracted and a smartphone is mounted to the charging dock;

FIG. 14. Back view of the present invention without the optional AC prongs feature while features are folded flat inside the body of the device;

FIG. 15. Isometric view of the present invention without AC prongs feature;

FIG. 16. Front view of the present invention while features are folded flat inside the body of the device;

FIG. 17. Back view of the present invention while features are folded flat inside the body of the device;

FIG. 18. Side view of the present invention while features are folded flat inside the body of the device;

FIG. 19. Side view of the present invention while features are folded flat inside the body of the device;

FIG. 20. Isometric view of the present invention while features are folded flat inside the body of the device;

FIG. 21. Isometric view of the present invention while features are folded flat inside the body of the device;

FIG. 22. Isometric view of the present invention while built-in dock, and desk stand are retracted and a smartphone is mounted to the charging dock;

FIG. 23. Side view of the present invention while built-in dock, is retracted and a smartphone is connected to the charging adapter and mounted to the charging dock;

FIG. 24. Side view of the present invention while built-in dock, is retracted and a smartphone is connected to the charging adapter and mounted to the charging dock;

FIG. 25. Isometric view of the present invention while built-in dock, USB input cable, cigarette lighter plug are retracted and a smartphone is mounted to the charging dock;

FIG. 26. Isometric view of the present invention while built-in dock. USB input cable, cigarette lighter plug are retracted and a smartphone is mounted to the charging dock;

FIG. 27. Isometric view of the present invention while built-in dock, is retracted and the charging adapter and mounted to the charging dock; and

FIG. 28. Side view of the present invention while built-in dock, is retracted and a smartphone is mounted to the charging adapter connected to charging dock.

### DETAILED DESCRIPTION

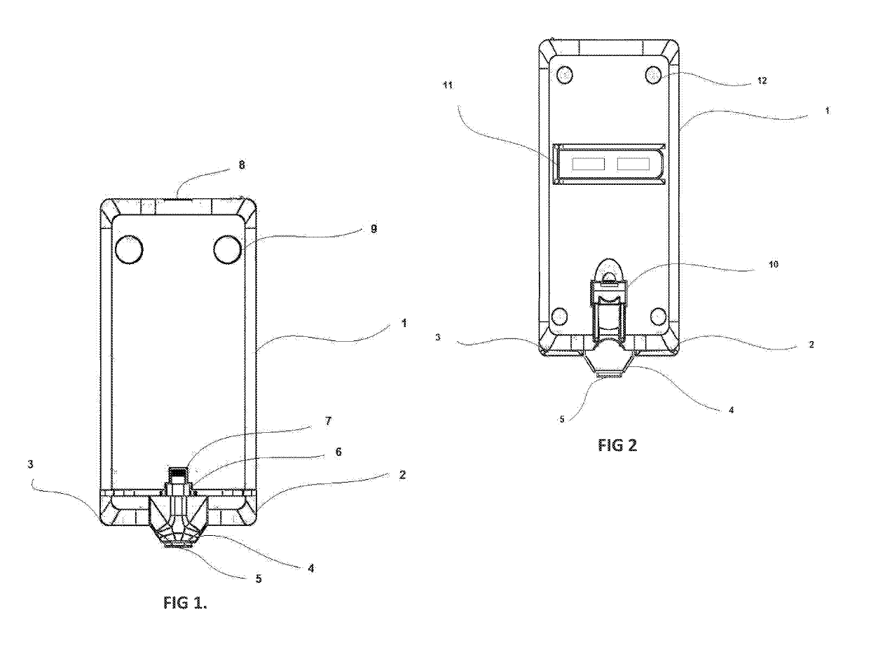

FIG. 1. Showing a drawing of the present invention 1 while features are folded flat inside the body of the device. A left arm 2 and a right arm 3 are folded flat. Smartphone charging adapter 6 is connected to universal charging dock 4. Push button 5 is connected to the universal charging dock from the other side of adapter 6. Charging adapter 6 is released from universal charging dock 4 if push button 5 is pressed. This allows easy change of adapter in order to place another type of adapter to support different smartphone's charging connector.

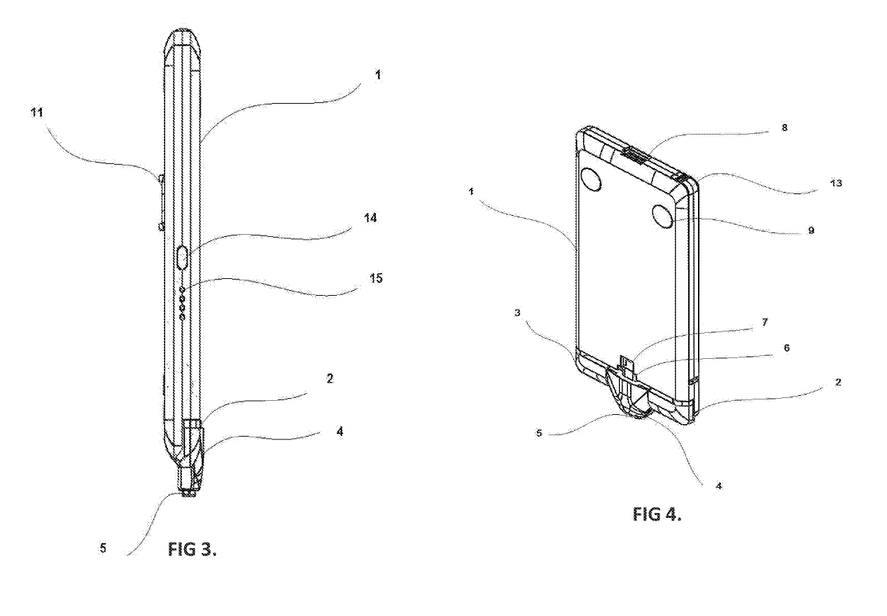

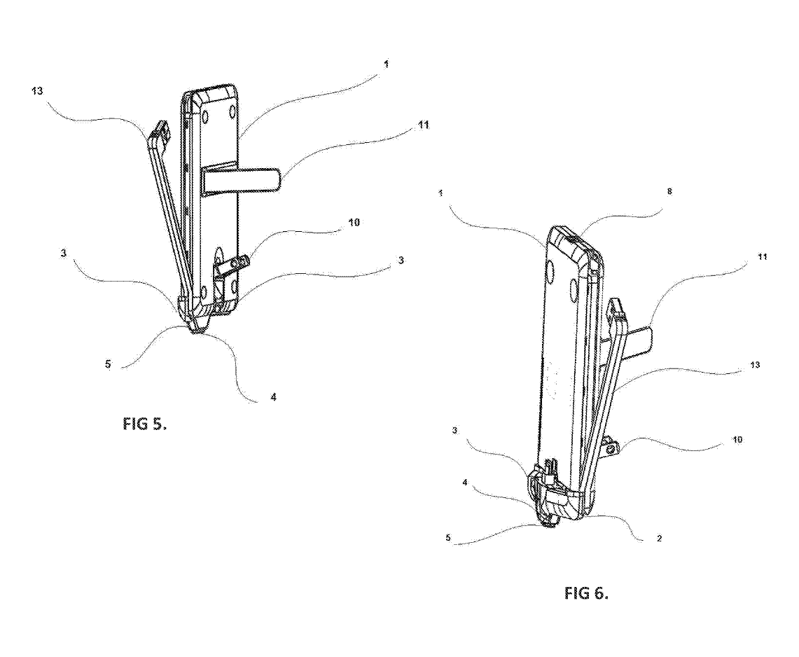

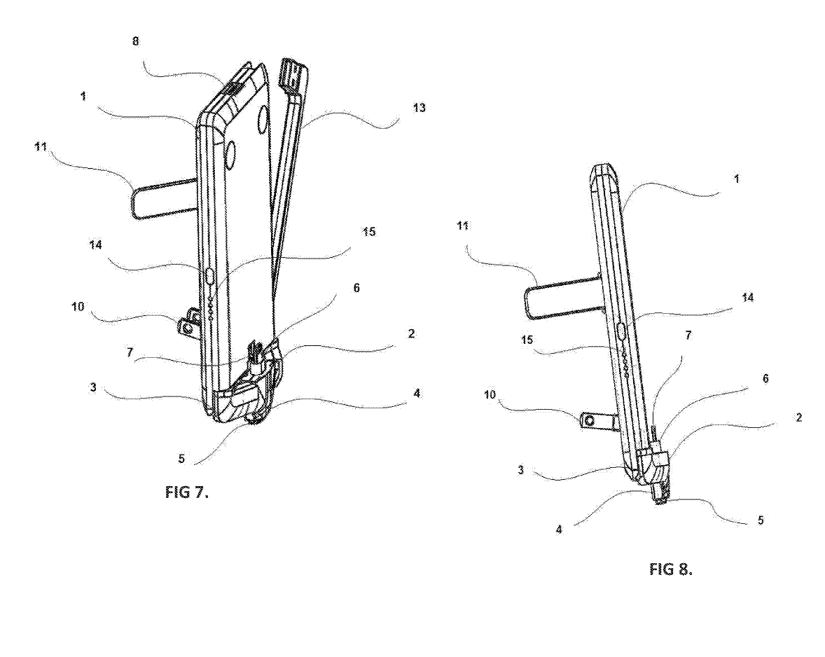

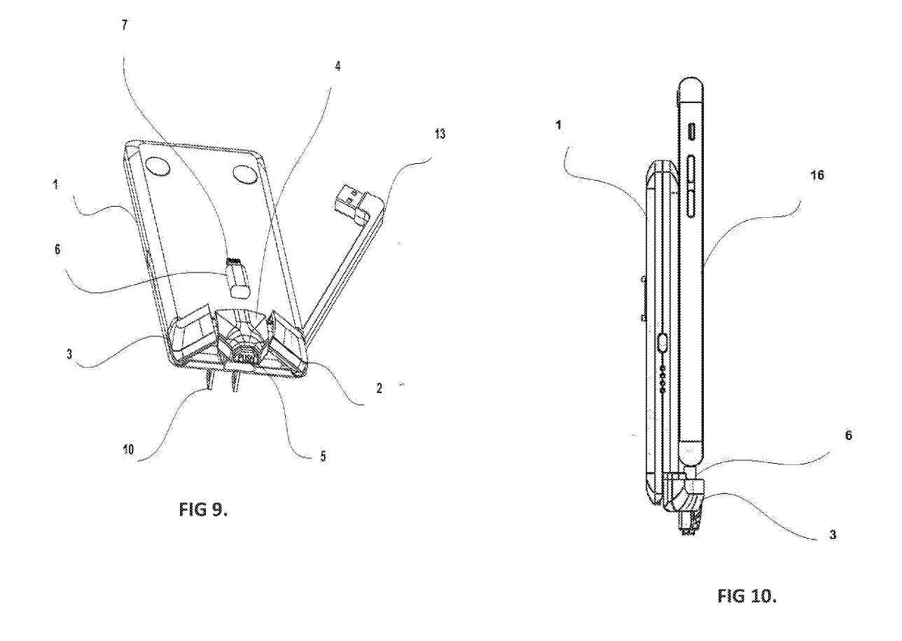

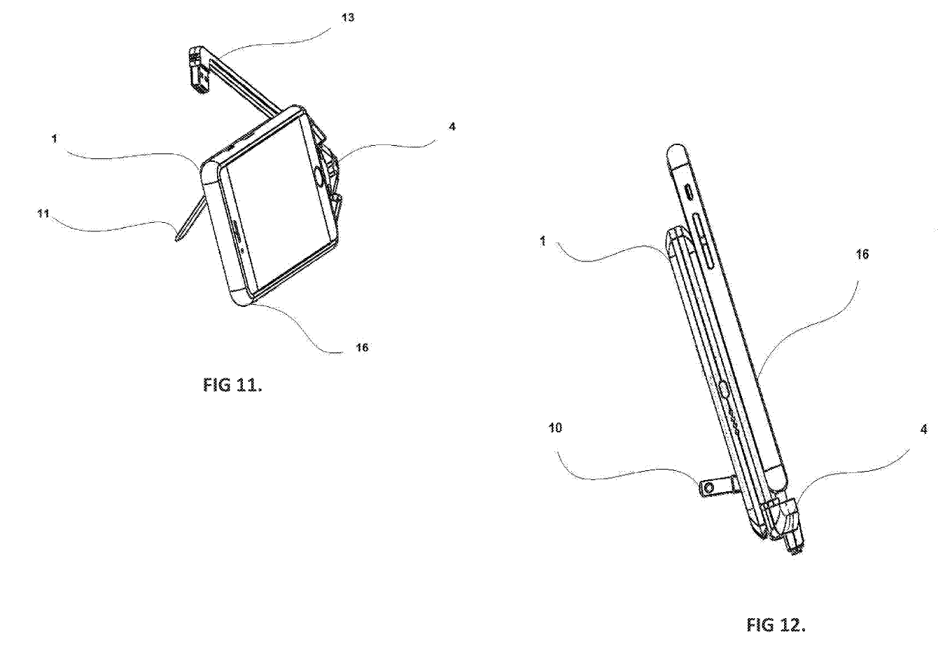

The embodiment shown in FIG. 3 is showing a drawing of the present invention from side view. While push button 15 is used to activate the device and initiate smartphone charging. In FIG. 5. Showing a drawing of the present invention while the universal charging dock is retracted. A left arm 2 and a right arm 3 are rotated outside and are extracted. Left arm 2 and 3 while in extracted position behave as a shelve to allow the phone to be placed on this shelve. A charging port inside the dock 4 is connected to charging adapter 6. Charging adapter 6 represents different connector types. For an example charging adapter 6 could be male micro USB connector to another to another type of connector. Charging port inside the dock 4 connected to charging adapter 6 can be then used to connect to a smart phone and to allow charging of smartphone's battery.

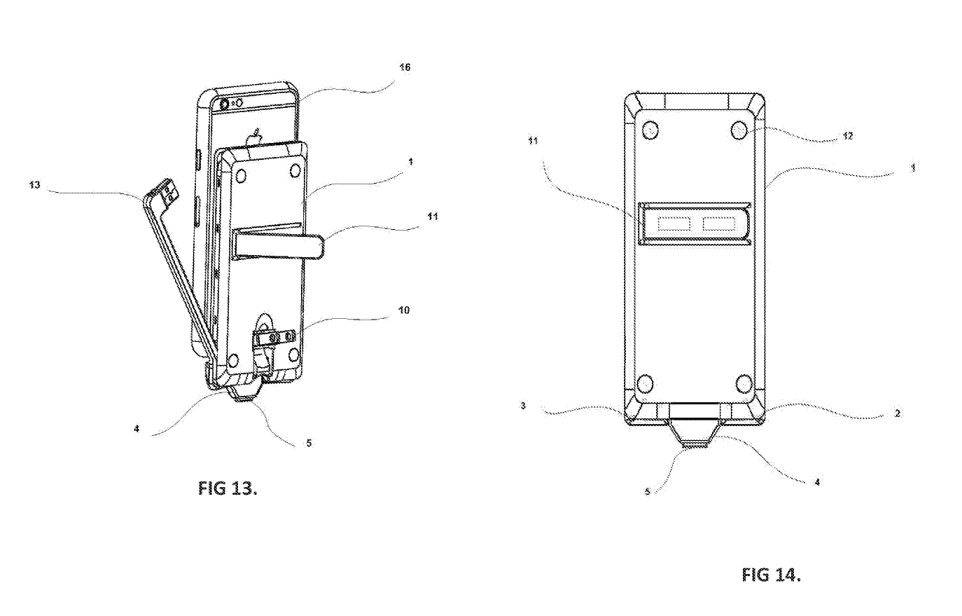

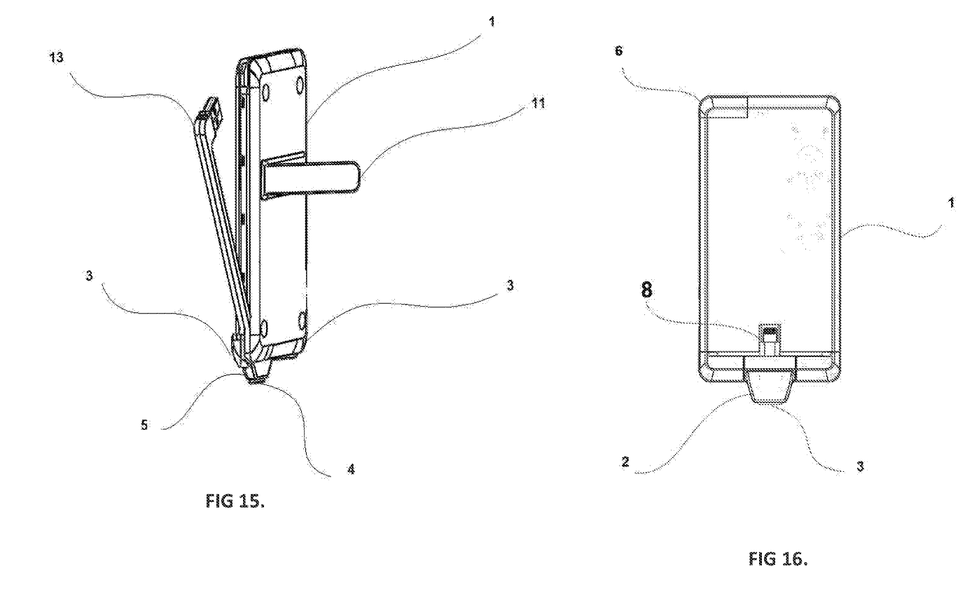

While the charging port inside the dock 4 connected to charging adapter 6 can be then used to connect to a smart phone and to allow charging of smartphone's battery. In FIG. 13. Showing a drawing of the present invention while built-in dock 4, USB input cable 13, AC prongs 10 and desk stand 11 are retracted and a smartphone 16 is mounted to the charging dock. The smartphone can be secured to the device by magnets, suctions cups, mechanical lever or the same. The user can decide to fold flat the desk stand 11. The device can then be mounted to an AC wall outlet or USB input cable and charge the built-in battery and the attached smartphone battery at the same time. When the user desires, he or she can disconnect the device from the power source, fold flat the features he does not want to use and continue charge the attached smartphone from the built-in device's battery and use the smart phone and the go at the same time.

Another embodiment, set forth in FIG. 14 showing a drawing of the present invention from back view. In this variation of the present invention, the device does not have AC wall charging capability and it is being charged by USB input ports. FIG. 16. Showing a drawing of the present invention 1 while features are folded flat inside the body of the device. Smartphone charging adapter 8 is connected to universal charging dock 4. Push button 5 is connected to the universal charging dock from the otherside of adapter 8. Charging adapter 8 is released from universal charging dock 4 if push button 5 is pressed. This allows easy change of adapter in order to place another type of adapter to support different smartphone's charging connector.

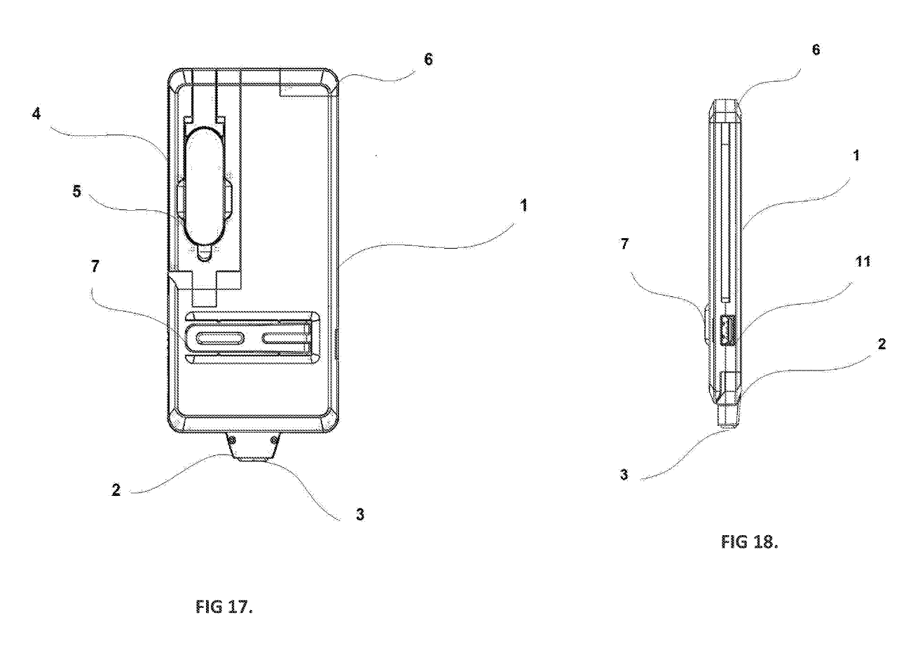

Another embodiment, set forth in FIG. 17. Showing a drawing of the back side of the present invention 1 while features are folded flat inside the body of the device. Cigarette lighter plug 5 is connected to retractable multi positions arm 4 currently folded flat inside the body of the device 1. In FIG. 18. Showing a drawing of the present invention while the universal charging dock 4 is retracted and behave as a shelve to allow the phone to be placed on this shelve. A charging port inside the dock 4 is connected to charging adapter 8. Charging adapter 8 represents different connector types. For an example charging adapter 8 could be male micro USB connector to another to another type of connector. Charging port side the dock 4 connected to charging adapter 8 can be then used to connect to a smart phone and to allow charging of smartphone's battery.

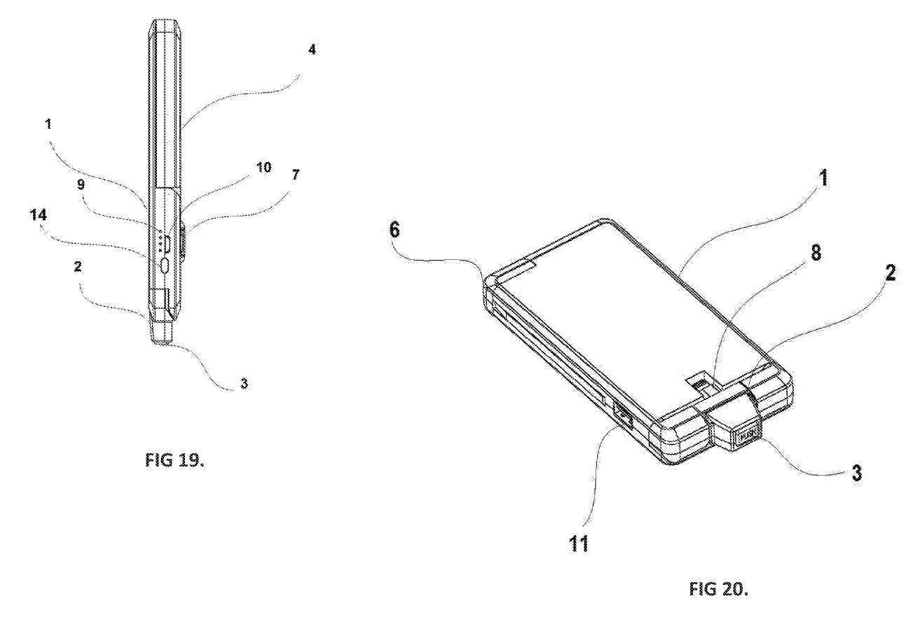

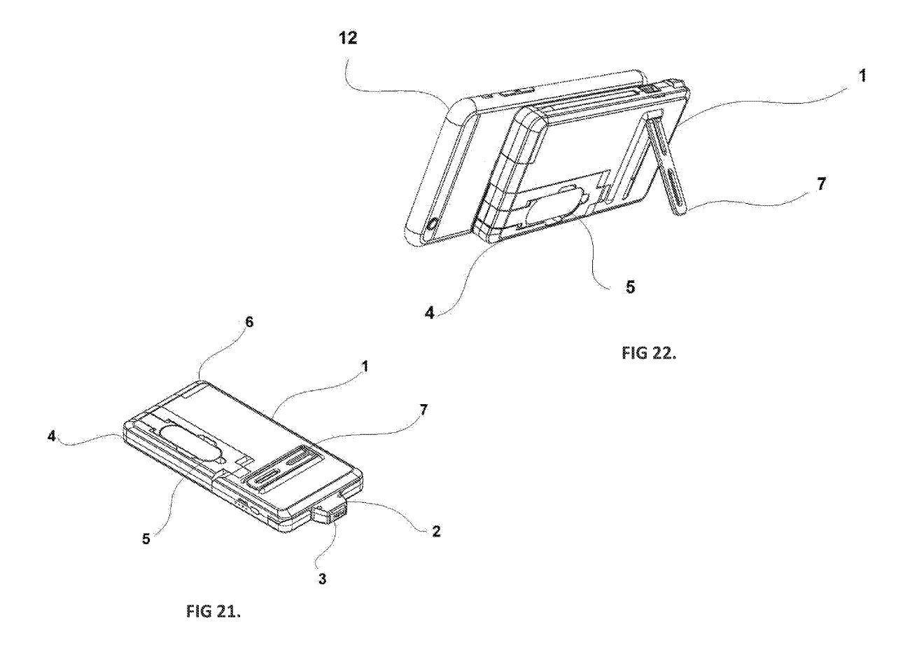

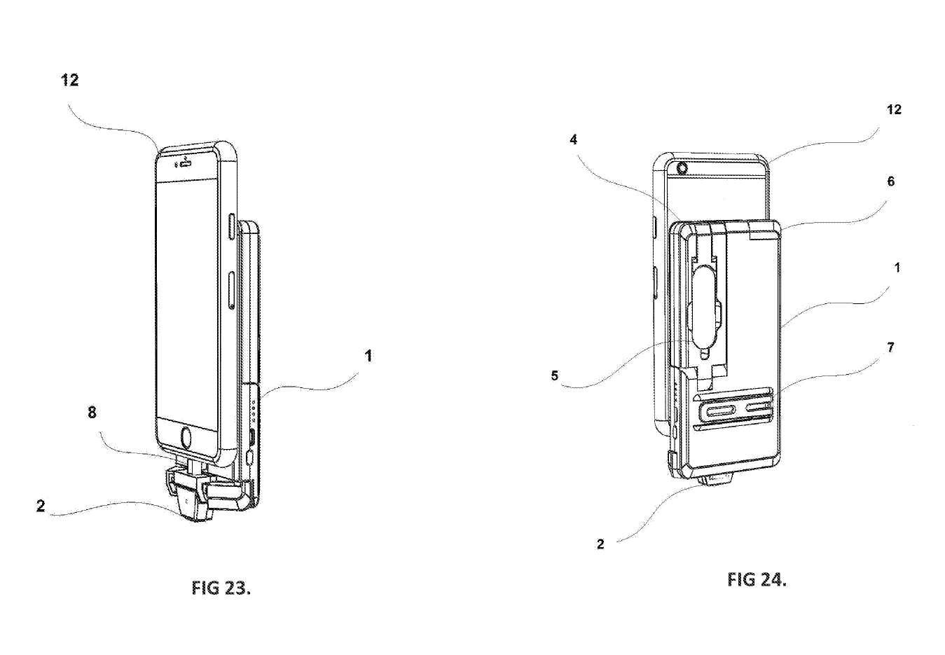

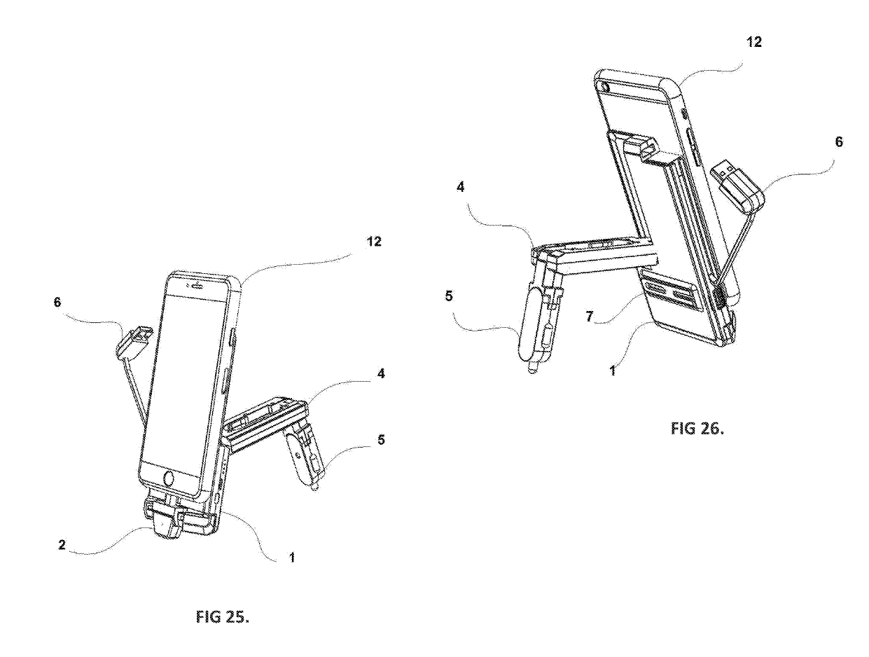

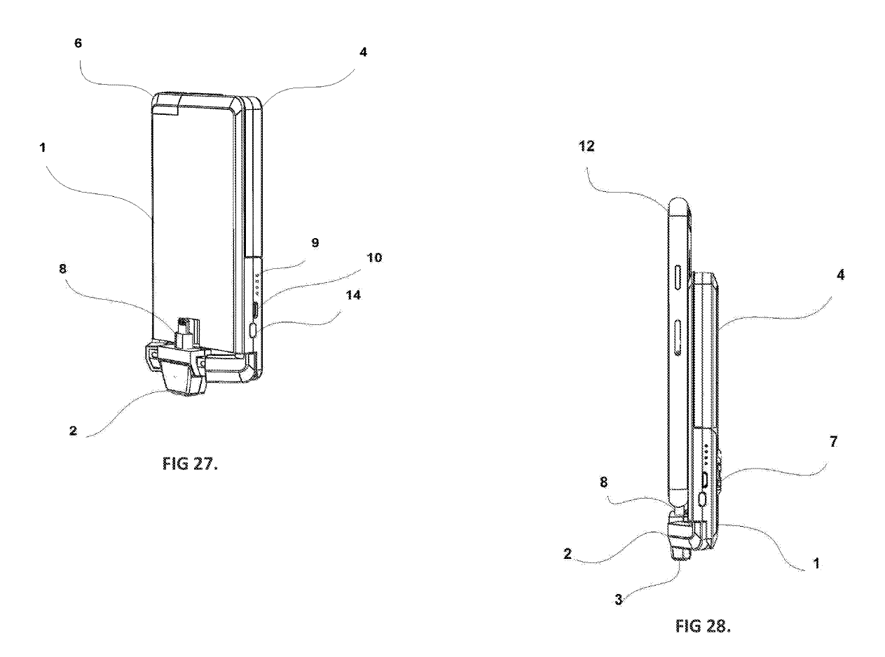

Another embodiment, set forth in FIG. 19 is showing a drawing of the present invention from side view. While push button 15 is used to activate the device and initiate smartphone charging. Similarly, in FIG. 20 the figure is showing a drawing of the present invention while built-in dock 4, USB input cable 6 and cigarette lighter plug are retracted and a smartphone 12 is mounted to the charging dock. The smartphone can be secured to the device by magnets, suctions cups, mechanical lever or the same. The device can then be mounted to car charging outlet or USB input cable and charge the built-in battery and the attached smartphone battery at the same time. The device then behaves as a smartphone holder in the car and a smartphone battery charger at the same time. When the user desires, he or she can disconnect the device from the power source, fold flat the features he does not want to use and continue charge the attached smartphone from the built-in device's battery and use the smart phone and the go at the same time.

In another embodiment AC pins for receiving AC voltage from an AC voltage source, said AC pins being rotatably coupled with said casing, said AC pins rotating from a stowed configuration in which said AC pins conform to the slim shape of said casing to a charging stance in which said AC pins extend normally posteriorly from said casing, in said stowed stance of said AC pins said AC pins rest in a respective niche within said casing. In addition a charging circuit for transforming said AC voltage to DC voltage adapted for charging said rechargeable device is provided.

A floating base bar having a DC plug mounted thereon, said DC plug providing said DC voltage to a charging port of said rechargeable device, said floating base bar supporting said rechargeable device during charging, said floating base bar moving from a stowed configuration in which said floating base bar and said DC plug conform to the slim shape of said casing, to a charging stance in which floating said floating base bar projecting beyond said casing such that said DC plug is exposed from said casing, and such that said floating base bar can support said rechargeable device. An embodiment provides two flexible rails coupled with said casing, said floating base bar being mounted on said flexible rails, said DC plug being connected to said charging circuit via wiring running through at least one of said flexible rails and through said floating base bar, said flexible rails can be twisted for aligning said base bar to the direction of the pulling force applied by a user when disconnecting said rechargeable device from said charger.

In another embodiment apparatus includes a casing having a slim shape and AC pins for receiving AC voltage from an AC voltage source, said AC pins being rotatably coupled with said casing, said AC pins rotating from a stowed configuration in which said AC pins conform to the slim shape of said casing to a charging stance in which said AC pins extend normally posteriorly from said casing, in said stowed stance of said AC pins said AC pins rest in a respective niche within said casing. And a charging circuit for transforming said AC voltage to DC voltage adapted for charging said rechargeable device. The aforementioned floating base bar having a DC plug mounted thereon, said DC plug providing said DC voltage to a charging port of said rechargeable device, said floating base bar supporting said rechargeable device during charging, said floating base bar moving from a stowed configuration in which said floating base bar and said DC plug conform to the slim shape of said casing, to a charging stance in which floating said floating base bar projecting beyond said casing such that said DC plug is exposed from said casing, and such that said floating base bar can support said rechargeable device; and two flexible rails coupled with said casing, said floating base bar being mounted on said flexible rails, said DC plug being connected to said charging circuit via wiring running through at least one of said flexible rails and through said floating base bar, said flexible rails can be twisted for aligning said base bar to the direction of the pulling force applied by a user when disconnecting said rechargeable device from said charger.

Although the invention herein has been described with respect to particular embodiments, it is understood that these embodiments are merely illustrative of the principles and applications of the present invention. It is therefore to be understood that numerous modifications may be made to the illustrative embodiments and that other arrangements may be devised without departing from the spirit and scope of the present invention.

What is claimed is:

1. An apparatus for charging a rechargeable device, comprising:
one or more electrically conductive features folded flat inside the body of the apparatus; wherein an apparatus left arm and an apparatus right arm are folded flat and a rechargeable device charging adapter is connected to the apparatus and a push button is connected to the apparatus from the other side of the rechargeable device charging adapter is released from the apparatus if the push button is pressed, whereby the rechargeable device charging adapter is released and another type of rechargeable device charging adapter may be affixed and whereby said another type of rechargeable device charging adapter supports a different rechargeable device charging connector.

2. The apparatus as set forth in claim 1, wherein one of the electrically conductive features folded flat inside the body of the apparatus includes a cigarette lighter adapter.

3. The apparatus as set forth in claim 1, wherein one of the electrically conductive features folded flat inside the body of the apparatus includes a wall outlet.

4. The apparatus as set forth in claim 1, wherein one of the electrically conductive features folded flat inside the body of the apparatus includes a wall outlet and a cigarette lighter adapter.

5. The apparatus as set forth in claim 1, wherein the body of the apparatus includes a battery and the battery is operatively interfaced with a rechargeable device charging adapter.

6. The apparatus as set forth in claim 1, wherein the body of the apparatus includes an integral battery and the battery is operatively interfaced with the rechargeable device charging adapter and the rechargeable device charging adapter has a first and a second side and the first side is configured to operatively interface with the apparatus and the second side is configured to operatively interface with the rechargeable device.

7. The apparatus as set forth in claim 1, wherein the body of the apparatus includes an integral battery and the battery is operatively interfaced with the rechargeable device charging adapter and a universal serial bus interface.
